(19) United States
(12) Patent Application Publication
(10) Pub. No.: US 2026/0048554 A1
(43) Pub. Date: Feb. 19, 2026

(54) BONDING PANEL CORE TO FIBER-REINFORCED THERMOPLASTIC SKIN(S)

(71) Applicant: Rohr, Inc., Chula Vista, CA (US)

(72) Inventors: Shyan Bob Shen, San Diego, CA (US); Michael van Tooren, San Diego, CA (US); Jon Josey, San Diego, CA (US); Hassan Zaidi, Lake Forest, CA (US)

(21) Appl. No.: 18/806,433

(22) Filed: Aug. 15, 2024

(51) Int. Cl. B29C 65/00; G10K 11/168

(52) U.S. Cl. CPC B29C 66/72525; B29C 66/721; B29C 66/7392; B29C 66/876; G10K 11/168

(57) ABSTRACT

A formation method is provided during which a thermoplastic film is arranged on a fiber-reinforced thermoplastic skin. The thermoplastic film is configured from or otherwise includes thermoplastic material. A heating device is moved to a location along the thermoplastic film, where the thermoplastic film is disposed between the fiber-reinforced thermoplastic skin and the heating device. The thermoplastic film is heated with the heating device to melt the thermoplastic film and provide a melted thermoplastic film. The heating device is moved away from the melted thermoplastic film. A honeycomb core is pressed against the melted thermoplastic film to bond the honeycomb core to the fiber-reinforced thermoplastic skin with the thermoplastic material.

### BACKGROUND

### 1. Technical Field

This disclosure relates generally to a structured panel and, more particularly, to forming a structured panel such as an acoustic panel.

### 2. Background Information

An aircraft propulsion system may include a sandwich panel such as an acoustic panel. Various methods for forming an acoustic panel are known in the art. While these known acoustic panel formation methods have various benefits, there is still room in the art for improvement.

### SUMMARY OF THE DISCLOSURE

According to an aspect of the present disclosure, a formation method is provided during which a thermoplastic film is arranged on a fiber-reinforced thermoplastic skin. The thermoplastic film is configured from or otherwise includes thermoplastic material. A heating device is moved to a location along the thermoplastic film, where the thermoplastic film is disposed between the fiber-reinforced thermoplastic skin and the heating device. The thermoplastic film is heated with the heating device to melt the thermoplastic film and provide a melted thermoplastic film. The heating device is moved away from the melted thermoplastic film. A honeycomb core is pressed against the melted thermoplastic film to bond the honeycomb core to the fiber-reinforced thermoplastic skin with the thermoplastic material.

According to another aspect of the present disclosure, another formation method is provided during which a thermoplastic film is arranged on a thermoplastic skin. The thermoplastic film is configured from or otherwise includes thermoplastic material. A heating device is moved to locate the heating device along the thermoplastic film, where the thermoplastic film is disposed between the thermoplastic skin and the heating device. The thermoplastic film is heated with the heating device to provide a melted thermoplastic film. The heating device is moved away from the melted thermoplastic film. A cellular core is pressed against the melted thermoplastic film to bond a plurality of sidewalls of the cellular core to the fiber-reinforced thermoplastic skin with the thermoplastic material. The cellular core includes a plurality of cavities and the plurality of sidewalls. Each of the cavities extends vertically through the cellular core. Each laterally adjacent pair of the cavities is separated by a respective one of the sidewalls.

According to still another aspect of the present disclosure, another formation method is provided during which a cellular core is arranged on a core support. The cellular core includes a plurality of cavities and a plurality of sidewalls. Each of the cavities extends vertically through the cellular core. Each laterally adjacent pair of the cavities is separated by a respective one of the sidewalls. A thermoplastic skin is arranged on a skin support. A thermoplastic film comprising thermoplastic material is arranged on the thermoplastic skin. The thermoplastic film is heated to provide a melted thermoplastic film. The core support and/or the skin support are moved to press the cellular core against the melted thermoplastic film and to bond one or more of the sidewalls to the thermoplastic skin through the thermoplastic material. The moving includes rotating the core support and/or rotating the skin support.

The heating device may be configured as or otherwise include an infrared heating device.

The heating device may be moved by translating the heating device along an axis.

The axis may be parallel with the thermoplastic film.

The heating device may be disposed vertically between the thermoplastic film and the honeycomb core during the heating of the thermoplastic film. The formation method may also include moving the honeycomb core vertically towards the melted thermoplastic film after the heating device is moved away from the melted thermoplastic film.

The honeycomb core may be located vertically above the thermoplastic film and the heating device during the heating of the thermoplastic film.

The formation method may also include moving the honeycomb core to a position adjacent the melted thermoplastic film prior to the pressing of the honeycomb core against the melted thermoplastic film. The moving of the honeycomb core may include rotating the honeycomb core about an axis.

The honeycomb core may be rotated ninety degrees about the axis during the moving of the honeycomb core.

The honeycomb core may be rotated one-hundred and eighty degrees about the axis during the moving of the honeycomb core.

The formation method may also include rotating the fiber-reinforced thermoplastic skin with the melted thermoplastic film prior to the pressing of the honeycomb core against the melted thermoplastic film.

The formation method may also include heating the honeycomb core with the heating device prior to the pressing of the honeycomb core against the melted thermoplastic film.

The formation method may also include: arranging a second thermoplastic film on the honeycomb core, the second thermoplastic film comprising second thermoplastic material; moving a second heating device to a location along the second thermoplastic film, wherein the second thermoplastic film is disposed between the honeycomb core and the second heating device; heating the second thermoplastic film with the second heating device to melt the second thermoplastic film and provide a melted second thermoplastic film; and moving the second heating device away from the melted second thermoplastic film. The melted second thermoplastic film may be disposed between the melted thermoplastic film and the honeycomb core as the honeycomb core is pressed against the melted thermoplastic film.

The formation method may also include: arranging the fiber-reinforced thermoplastic skin with a first support; arranging the honeycomb core with a second support; and biasing the second support towards the first support with a stack of material between the first support and the second support. The stack of material may include the fiber-reinforced thermoplastic skin, the melted thermoplastic skin and the honeycomb core.

The honeycomb core may be configured from or otherwise include a metal material.

The honeycomb core may be configured from or otherwise include a non-metal material.

The thermoplastic material may be a thermoplastic resin. The thermoplastic film may only include or consist essentially of the thermoplastic resin.

The formation method may also include cleaning the honeycomb core prior to the pressing of the honeycomb core against the melted thermoplastic film.

The formation method may also include cleaning the thermoplastic film prior to arranging the thermoplastic film on the fiber-reinforced thermoplastic skin.

The formation method may also include cleaning the fiber-reinforced thermoplastic skin prior to arranging the thermoplastic film on the fiber-reinforced thermoplastic skin.

The present disclosure may include any one or more of the individual features disclosed above and/or below alone or in any combination thereof.

The foregoing features and the operation of the invention will become more apparent in light of the following description and the accompanying drawings.

### BRIEF DESCRIPTION OF THE DRAWINGS

FIG. 1 is a partial side sectional illustration of an acoustic panel.

FIG. 2 is a partial cross-sectional illustration of the acoustic panel.

FIG. 3 is a partial sectional illustration of a perforated face skin.

FIG. 4 is a partial sectional illustration of a non-perforated back skin.

FIG. 5 is a partial sectional illustration of the acoustic panel depicting bonds between a cellular core and the face and the back skins.

FIG. 6 is a partial perspective cutaway illustration of the acoustic panel.

FIG. 7 is a flow diagram of a method for forming a structured panel such as the acoustic panel.

FIGS. 8A-D are schematic sectional illustrations depicting steps during a structured panel formation method.

FIGS. 9A and 9B are schematic sectional illustrations depicting select steps during another structured panel formation method.

FIGS. 10A and 10B are schematic sectional illustrations depicting select steps during another structured panel formation method.

FIG. 11 is a schematic sectional illustration of dual sided heating device for the structured panel formation method of FIGS. 8A-D.

### DETAILED DESCRIPTION

The present disclosure includes methods for forming a structured panel such as, but not limited to, a sandwich panel. The term “forming” may describe a method for original manufacture of the structured panel; e.g., creating a brand new structured panel. The term “forming” may also or alternatively describe a method for remanufacture or otherwise repairing of the structured panel; e.g., restoring one or more features of a previously formed structured panel to brand new condition, similar to brand new condition, better than brand new condition, etc. The term “structured” may be used to describe a relatively stiff panel; e.g., a panel including a cellular core which is connected to and structurally supports and/or reinforces one or more skins as described below. While the structured panel itself is structured, the structured panel may or may not form a structural member of another device or structure. Such structured panels are relatively lightweight and, thus, beneficial for use in the aerospace industry, for example.

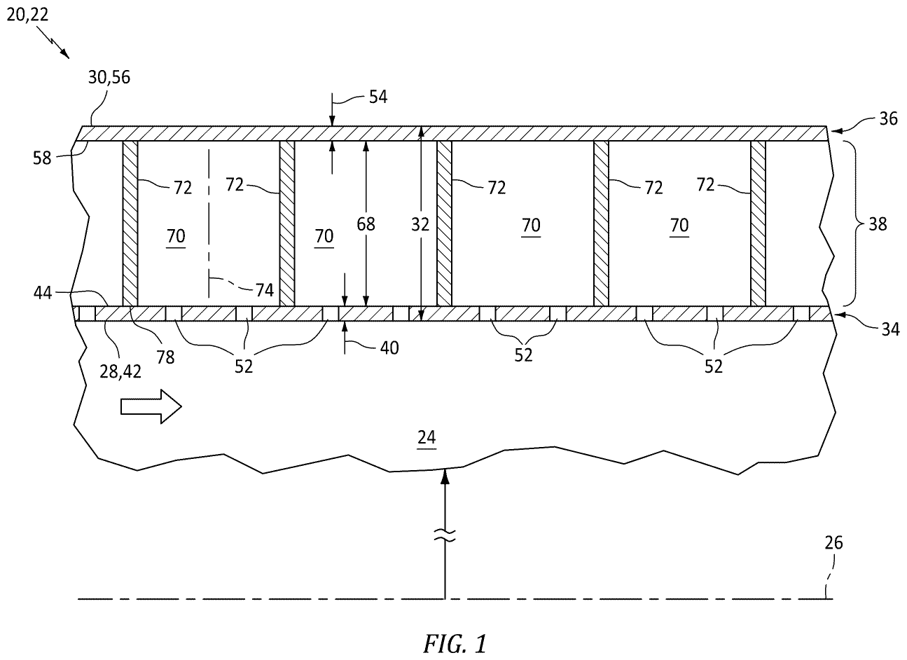

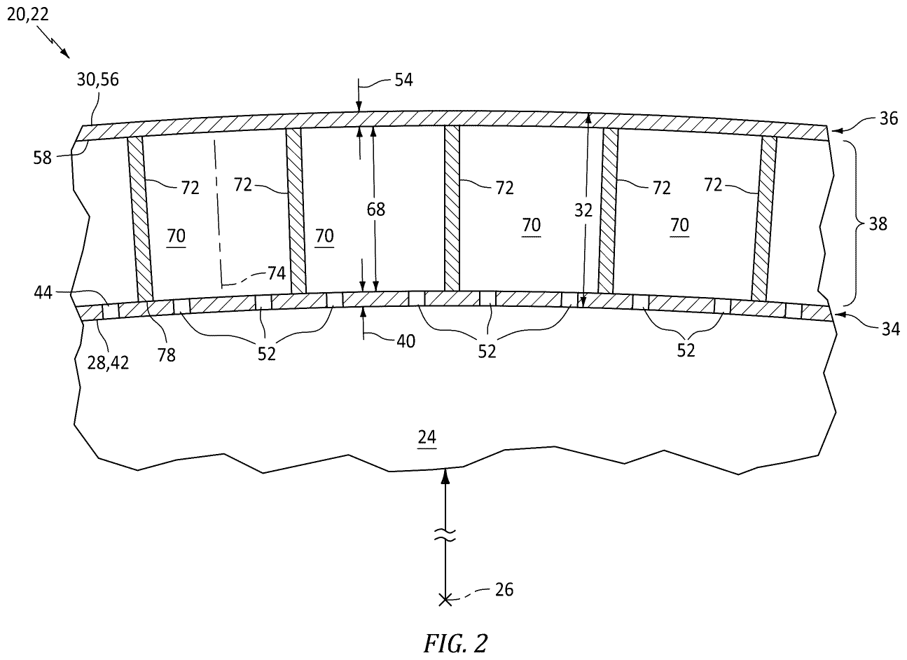

FIGS. 1 and 2 illustrate an exemplary embodiment of the structured panel configured as an acoustic panel 20 (e.g., an acoustic sandwich panel) for an aircraft. This acoustic panel 20 may be configured to attenuate sound (e.g., noise) generated by a propulsion system of the aircraft. The aircraft propulsion system may be a turbofan propulsion system, a turbojet propulsion system, a turboprop propulsion system or any other ducted-rotor and/or open-rotor aircraft propulsion system. The acoustic panel 20 may be part of a housing (e.g., a nacelle) for a powerplant of the aircraft propulsion system; e.g., a gas turbine engine, an electric motor, etc. The acoustic panel 20, for example, may be configured as or otherwise included as part of an inner barrel, an outer barrel, a translating sleeve, a blocker door, a bifurcation, or other nacelle components. Alternatively, the acoustic panel 20 may be part of another component of the aircraft such as, but not limited to, an engine pylon, an aircraft wing, an aircraft control surface, or an aircraft fuselage. The acoustic panel 20 may also or alternatively be configured to attenuate aircraft related sound other than the sound generated by the aircraft propulsion system. Moreover, while the acoustic panel 20 is described with reference to the aircraft propulsion system, the acoustic panel 20 may alternatively be arranged with an auxiliary power unit (APU) for the aircraft, or any other device which generates sound to be attenuated, both for components outside and/or inside of the aircraft. However, for ease of description, the acoustic panel 20 of FIGS. 1 and 2 is described below as attenuating propulsion system sound and with respect to a component 22 (e.g., barrel) of the powerplant housing along a flowpath 24 (e.g., an inlet flowpath, a bypass flowpath, etc.) within the aircraft propulsion system. It is worth noting, while the structured panel is described below as the acoustic panel 20 for ease of description, it is contemplated the structured panel may alternatively be configured as a non-acoustic panel; e.g., a sandwich panel with non-perforated skins.

Referring to FIG. 1, the acoustic panel 20 extends axially along an axis 26.

Briefly, this axis 26 may be a centerline axis of the aircraft propulsion system, a centerline axis of the powerplant housing and/or a centerline axis of the component 22 (e.g., the barrel) which is formed by or otherwise includes the acoustic panel 20. The acoustic panel 20 extends radially from a radial inner side 28 of the acoustic panel 20 to a radial outer side 30 of the acoustic panel 20. Referring to FIG. 2, the acoustic panel 20 extends circumferentially about (e.g., partially or completely around) the axis 26. The component 22 and/or its acoustic panel 20 may thereby have a curved (e.g., arcuate, cylindrical, conical, frustoconical) geometry.

With the arrangement of FIGS. 1 and 2, a vertical thickness 32 of the acoustic panel 20 extends in a radial direction relative to the axis 26, and a lateral plane of the acoustic panel 20 extends axially along and circumferentially about the axis 26. The present disclosure, however, is not limited to such an exemplary curved geometry nor such an orientation relative to the axis 26. For example, where the acoustic panel 20 is configured as or part of a sidewall of the bifurcation, the vertical thickness 32 may extend tangentially to a circular reference line about the axis 26, and the lateral plane may extend axially and/or radially relative to the axis 26. However, for ease of description, the acoustic panel 20 is described below with reference to the orientation of FIGS. 1 and 2 where a vertical direction extends radially relative to the axis 26, a first lateral direction extends axially along the axis 26, and a second lateral direction extends circumferentially about the axis 26.

The acoustic panel 20 of FIGS. 1 and 2 includes a perforated face skin 34, a solid (e.g., non-perforated) back skin 36 and a cellular core 38. For ease of description, the face skin 34 is described below as an inner skin of the acoustic panel 20 and the back skin 36 is described below as an outer skin of the acoustic panel 20. With such an arrangement, the acoustic panel 20 and its face skin 34 may form an outer peripheral boundary of at least a portion of the flowpath 24 within the aircraft propulsion system. It is contemplated, however, the face skin 34 may alternatively be the acoustic panel outer skin and the back skin 36 may alternatively be the acoustic panel inner skin with otherwise the same acoustic panel configuration of FIGS. 1 and 2. With such an arrangement, the acoustic panel 20 and its face skin 34 may form an inner peripheral boundary of at least a portion of the flowpath 24 within the aircraft propulsion system. The present disclosure, of course, is not limited to the foregoing exemplary arrangements. The acoustic panel 20, for example, may form a circumferential side boundary of the flowpath 24 and/or may otherwise be located with the aircraft propulsion system and/or the aircraft.

The face skin 34 of FIGS. 1 and 2 extends axially along and circumferentially about the axis 26. The face skin 34 has a vertical thickness 40. This face skin thickness 40 of FIGS. 1 and 2 extends radially between opposing exterior and interior sides 42 and 44 of the face skin 34, where the face skin exterior side 42 is also the inner side 28 of the acoustic panel 20 of FIGS. 1 and 2. The face skin thickness 40 may remain uniform (e.g., constant, the same) as the face skin 34 extends axially along and/or circumferentially about the axis 26. Alternatively, the face skin thickness 40 may be varied as the face skin 34 extends axially along and/or circumferentially about the axis 26.

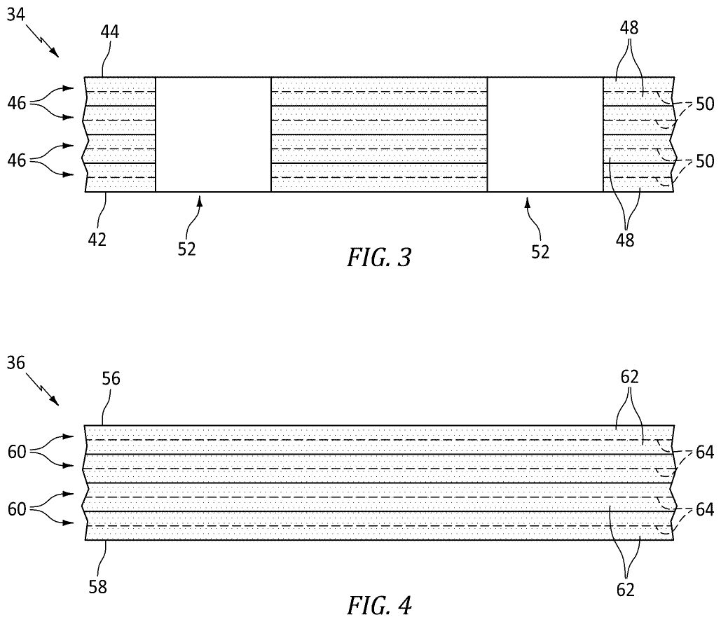

Referring to FIG. 3, the face skin 34 may be formed as a composite skin; e.g., a fiber-reinforced thermoplastic skin. The face skin 34 of FIG. 3, for example, includes one or more layers 46 of face skin material arranged in a stack and consolidated together to form a single monolithic member of the acoustic panel 20 (see FIGS. 1 and 2). The face skin material may be a fiber-reinforced composite material. Each layer 46 of the face skin material, for example, may include a thermoplastic matrix 48 and fiber reinforcement 50 embedded within the thermoplastic matrix 48. The thermoplastic matrix 48 may be a thermoplastic resin such as, but not limited to, thermoplastic film polyamide (PA), polyamide-imide (PAI), polyarylsulfone (PAS), polyethersulfone (PES), polyoxymethylene (POM), polyphenylene sulphide (PPS), polyether ether ketone (PEEK), polyetherimide (PEI), polyethylene terephthalate (PET), polyphthalamide (PPA), poly ether ketone ketone (PEKK), or poly aryl ether ketone (PAEK). The fiber reinforcement 50 may include fiberglass fibers, carbon fiber fibers, aramid (e.g., Kevlar®) fibers and/or the like. The fiber reinforcement 50 may be arranged as a (e.g., unidirectional, woven or unwoven) sheet of fibers and/or chopped fibers. The present disclosure, however, is not limited to such exemplary face skin materials.

The face skin 34 includes a plurality of perforations 52; e.g., apertures such as through-holes. The face skin perforations 52 are distributed axially and/or circumferentially along the face skin 34 and may (or may not) be equispaced from one another along the face skin 34. Each of the face skin perforations 52 extends longitudinally along a centerline of the respective face skin perforations 52 through the face skin 34 and its layers 46 from the face skin exterior side 42 to the face skin interior side 44. Note, for non-acoustic panel applications, the face skin 34 may alternatively omit the face skin perforations 52 and be configured as a solid (e.g., non-perforated) skin like the back skin 36 described below.

The back skin 36 of FIGS. 1 and 2 extends axially along and circumferentially about the axis 26. The back skin 36 has a vertical thickness 54. This back skin thickness 54 of FIGS. 1 and 2 extends radially between opposing exterior and interior sides 56 and 58 of the back skin 36, where the back skin exterior side 56 is also the outer side 30 of the acoustic panel 20 of FIGS. 1 and 2. The back skin thickness 54 may remain uniform as the back skin 36 extends axially along and/or circumferentially about the axis 26. Alternatively, the back skin thickness 54 may be varied as the back skin 36 extends axially along and/or circumferentially about the axis 26. Referring again to FIGS. 1 and 2, the back skin thickness 54 may be equal to or different (e.g., greater) than the face skin thickness 40.

Referring to FIG. 4, the back skin 36 may be formed as a composite skin; e.g., a fiber-reinforced thermoplastic skin. The back skin 36 of FIG. 4, for example, includes one or more layers 60 of back skin material arranged in a stack and consolidated together to form a single monolithic member of the acoustic panel 20 (see FIGS. 1 and 2). The back skin material may be a fiber-reinforced composite material. Each layer 60 of the back skin material, for example, may include a thermoplastic matrix 62 and fiber reinforcement 64 embedded within the thermoplastic matrix 62. The thermoplastic matrix 62 may be a thermoplastic resin such as, but not limited to, thermoplastic film polyamide (PA), polyamide-imide (PAI), polyarylsulfone (PAS), polyethersulfone (PES), polyoxymethylene (POM), polyphenylene sulphide (PPS), polyether ether ketone (PEEK), polyetherimide (PEI), polyethylene terephthalate (PET), polyphthalamide (PPA), poly ether ketone ketone (PEKK), or poly aryl ether ketone (PAEK). The fiber reinforcement 64 may include fiberglass fibers, carbon fiber fibers, aramid (e.g., Kevlar®) fibers and/or the like. The fiber reinforcement 64 may be arranged as a (e.g., unidirectional, woven or unwoven) sheet of fibers and/or chopped fibers. The present disclosure, however, is not limited to such exemplary back skin materials.

In some embodiments, the back skin material may be the same as the face skin material. In other embodiments, the back skin material may be different than the face skin material. The back skin material, for example, may include a different thermoplastic matrix and/or a different fiber reinforcement than the face skin material.

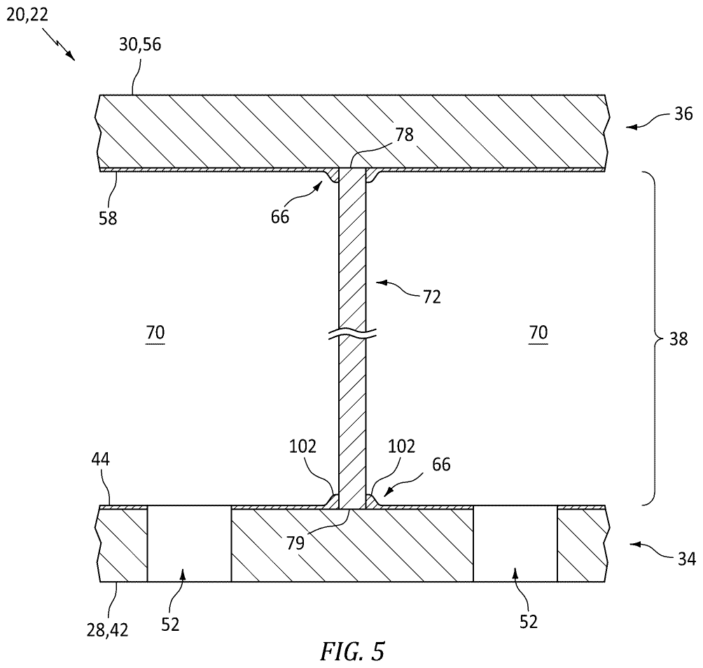

Referring to FIGS. 1 and 2, the cellular core 38 is arranged and extends radially between the face skin 34 and the back skin 36. One side of the cellular core 38, for example, may be abutted radially against the face skin interior side 44. Another side of the cellular core 38 may be abutted radially against the back skin interior side 58. The cellular core 38 is also connected to the face skin 34 and/or the back skin 36. Each composite skin 34, 36 of FIG. 5, for example, is bonded to the cellular core 38 by a bonding material 66 (e.g., thermoplastic material from a thermoplastic film) as described below in further detail. The bonding material 66 may be (e.g., only include) a thermoplastic resin such as, but not limited to, thermoplastic film polyamide (PA), polyamide-imide (PAI), polyarylsulfone (PAS), polyethersulfone (PES), polyoxymethylene (POM), polyphenylene sulphide (PPS), polyether ether ketone (PEEK), polyetherimide (PEI), polyethylene terephthalate (PET), polyphthalamide (PPA), poly ether ketone ketone (PEKK), or poly aryl ether ketone (PAEK). The present disclosure, however, is not limited to such exemplary bonding materials.

In some embodiments, the bonding material 66 may be the same as the thermoplastic matrix 48 in the face skin 34 of FIG. 3 and/or the thermoplastic matrix 62 in the back skin 36 of FIG. 4. In other embodiments, the bonding material 66 may be different than the thermoplastic matrix 48 in the face skin 34 of FIG. 3 and/or the thermoplastic matrix 62 in the back skin 36 of FIG. 4.

The cellular core 38 of FIGS. 1 and 2 extends axially along and circumferentially about the axis 26. The cellular core 38 has a vertical thickness 68. This core thickness 68 of FIGS. 1 and 2 extends radially between and to the face skin 34 at its face skin interior side 44 and the back skin 36 at its back skin interior side 58. The core thickness 68 may remain uniform as the cellular core 38 extends axially along and/or circumferentially about the axis 26. Alternatively, the core thickness 68 may change; e.g., increase or decrease. The core thickness 68, for example, may taper at or near one or more sides of the cellular core 38. The core thickness 68 may be substantially larger than the face skin thickness 40 and/or the back skin thickness 54. The core thickness 68, for example, may be at least two to ten times (2-10×), or more, larger than the face skin thickness 40 and/or the back skin thickness 54. The cellular core 38 of the present disclosure, however, is not limited to such an exemplary dimensional relationship and may vary based on sound attenuation requirements, space requirements, etc.

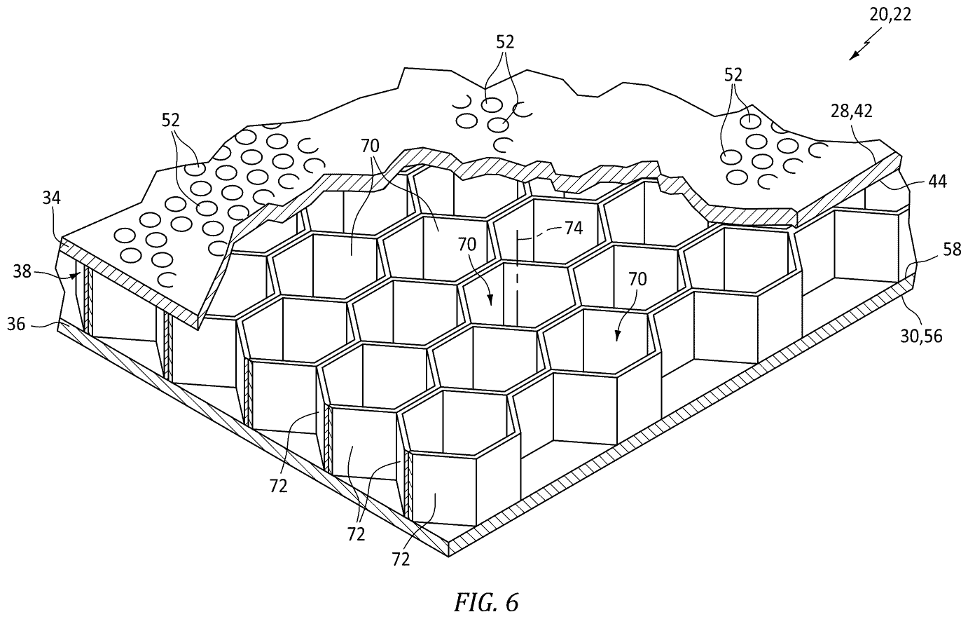

The cellular core 38 of FIGS. 1 and 2 is configured with one or more internal core cavities 70 (e.g., open internal chambers, acoustic resonance chambers, etc.) radially between the face skin 34 and the back skin 36. Referring to FIG. 6, the cellular core 38 may be configured as a honeycomb core. The cellular core 38 of FIG. 6, for example, includes a plurality of corrugated sidewalls 72. These corrugated sidewalls 72 are arranged in a side-by-side array and are connected to one another such that each neighboring (e.g., adjacent) pair of the corrugated sidewalls 72 forms an array of the core cavities 70 laterally (e.g., circumferentially and/or axially) therebetween. The cellular core 38 and its corrugated sidewalls 72 may be constructed from or otherwise include a core material such as metal; e.g., aluminum (Al), titanium (Ti) or other types of sheet metal. The present disclosure, however, is not limited to such an exemplary cellular core construction nor material. For example, in other embodiments, the cellular core 38 and its corrugated sidewalls 72 may be constructed from or otherwise include a fiber-reinforced composite. Examples of this fiber-reinforced composite include, but are not limited to, a fire-resistant fiber reinforcement such as aramid fibers (e.g., Nomex® fibers) embedded in a polymer matrix; e.g., a thermoset resin.

Each core cavity 70 of FIGS. 1 and 2 extends radially within/through the cellular core 38 along a respective centerline 74 of the respective core cavity 70 between and to the face skin 34 at its face skin interior side 44 and the back skin 36 at its back skin interior side 58. One or more or all of the core cavities 70 may thereby each overlap and be fluidly coupled with a respective set of one or more of the face skin perforations 52. Referring to FIG. 6, each of the core cavities 70 has a cross-sectional geometry (e.g., shape, size, etc.) when viewed in a reference plane; e.g., a plane perpendicular to the cavity centerline 74 of the respective core cavity 70. This cavity cross-sectional geometry may have a polygonal shape such as a hexagonal shape. The present disclosure, however, is not limited to foregoing exemplary cellular core configuration. Furthermore, various other types of honeycomb cores and, more generally, various other types of cellular cores including various other types of honeycomb cores for an acoustic panel as well as non-acoustic panel applications are known in the art, and the present disclosure is not limited to any particular ones thereof.

The acoustic panel 20 of FIGS. 1 and 2 is configured as a single-degree of freedom (SDOF) acoustic panel. Each of the core cavities 70 of FIGS. 1 and 2, for example, extends radially uninterrupted from the face skin 34 to the back skin 36. With such an arrangement, the acoustic panel 20 may be tuned to attenuate, for example, a select frequency of sound, which tuning may be based on a radial height of each core cavity 70/the core thickness 68. The present disclosure, however, is not limited to single-degree of freedom acoustic panel applications. It is contemplated, for example, at least (or only) one perforated septum, for example, may be arranged in each of the core cavities 70 (or a subset of the core cavities 70) to configure the acoustic panel 20 as a multi-degree of freedom (e.g., a double-degree of freedom) acoustic panel. Various types and configurations of acoustic panel septums are known in the art, and the present disclosure is not limited to any particular ones thereof.

During operation of the acoustic panel 20 of FIGS. 1 and 2, sound waves may enter a respective core cavity 70 through the respective face skin perforation(s) 52. These sound waves may travel through the core cavity 70 and reflect against the back skin 36. The reflected sound waves may travel back through the core cavity 70 and exit the acoustic panel 20 through the respective face skin perforation(s) 52, where those reflected sound waves may be out of phase from and destructively interfere with incoming soundwaves. Of course, the sound waves may also or alternatively reflect against one or more other elements of the acoustic panel 20 which may further influence sound attenuation.

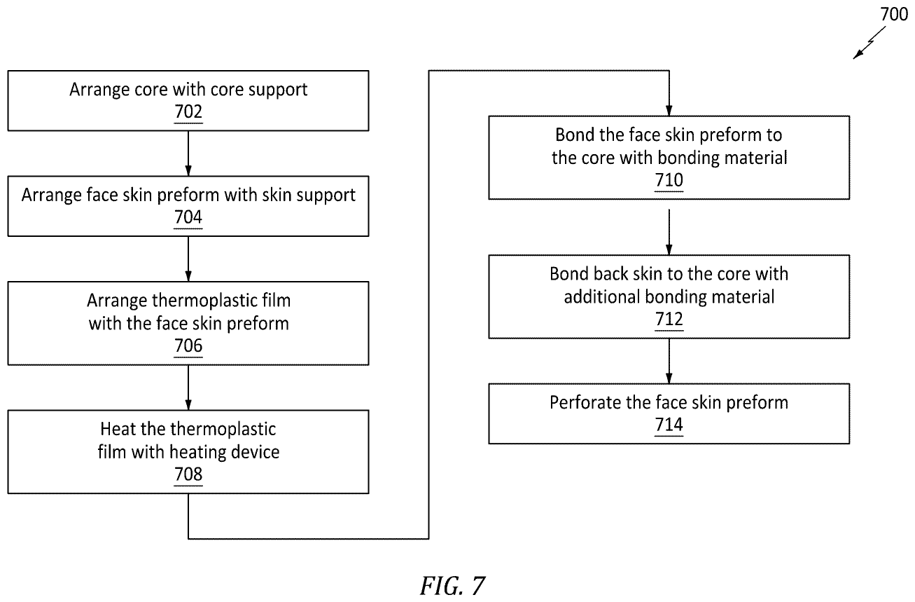

FIG. 7 is a flow diagram of a method 700 for forming a structured panel such as, but not limited to, a sandwich panel. For ease of description, the formation method 700 is described below with respect to forming the acoustic panel 20 described above. The formation method 700 of the present disclosure, however, is not limited to forming such an exemplary acoustic panel nor to forming acoustic-type structured panels. The formation method 700, for example, may alternatively be performed to form a non-acoustic structured panel with a single one of the skins 34, 36 or both of the skins 34 and 36, which skin(s) 34, 36 may or may not be perforated.

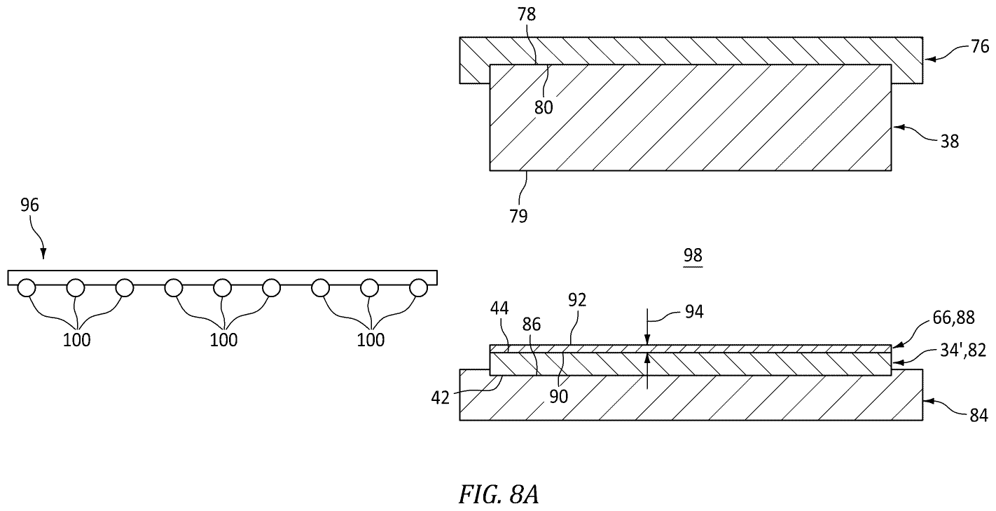

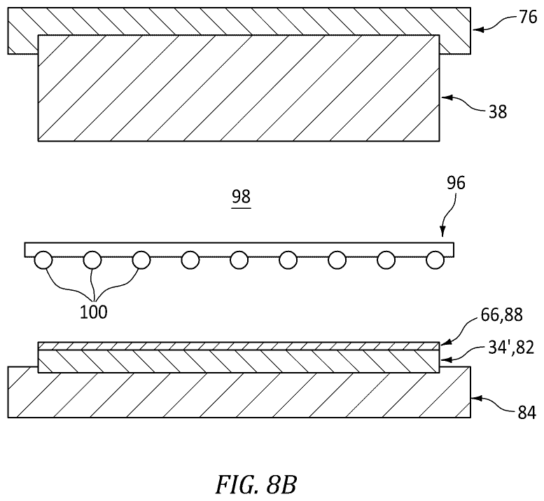

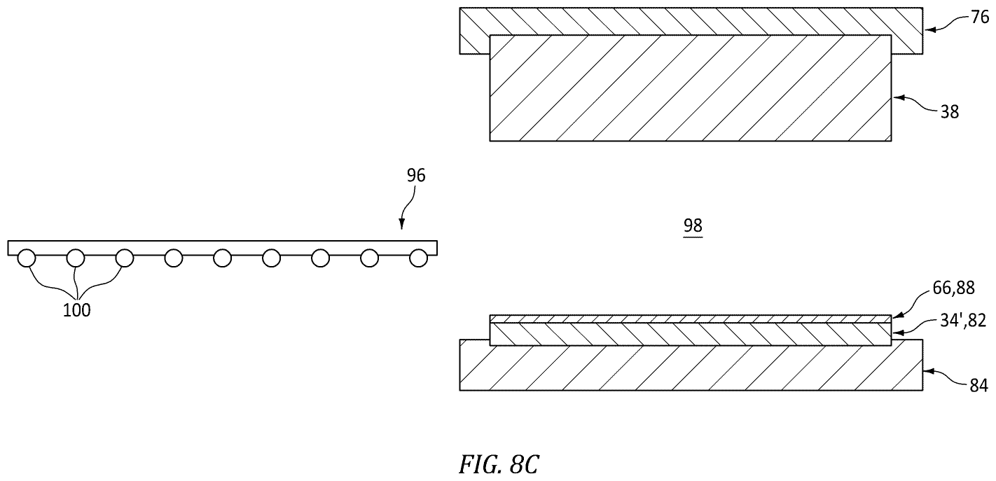

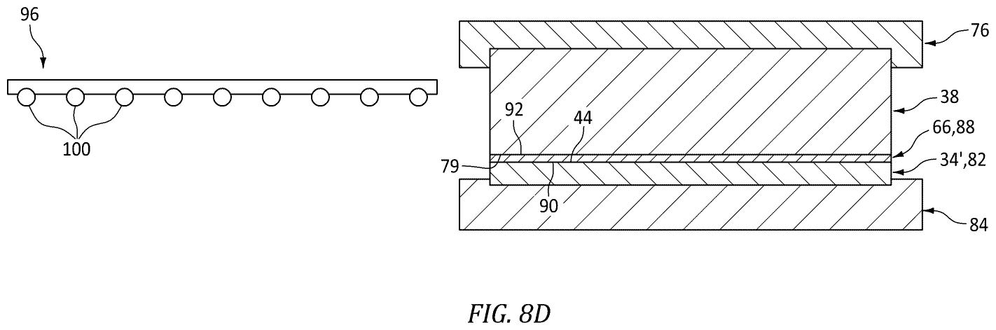

In step 702, referring to FIG. 8A, the cellular core 38 (e.g., the honeycomb core) is arranged with a rigid core support 76; e.g., (e.g., metal) tooling such as a formation die, a support plate, etc. The cellular core 38 of FIG. 8A, for example, is disposed vertically next to a bottom of the core support 76 such that a first (e.g., top) side 78 of the cellular core 38 is abutted against, contacts and/or otherwise engages a (e.g., bottom) support surface 80 of the core support 76, which core first side 78 is vertically opposite a second (e.g., bottom) side 79 of the cellular core 38. The cellular core 38 may also be attached to the core support 76 by a fixture and/or fasteners to temporarily fix the cellular core 38 to the core support 76 for the formation method 700.

Prior to (or after) arranging the cellular core 38 with the core support 76, the cellular core 38 may be prepared for bonding. The cellular core 38, for example, may be cleaned to remove any debris, fluids (e.g., oils, coatings, etc.) or the like from any mating surface or an entirety of the cellular core 38.

In step 704, a first composite skin 82 is arranged with a rigid skin support 84; e.g., (e.g., metal) tooling such as a formation die, a support plate, etc. For ease of description, the first composite skin 82 is described below as a preform 34′ of the face skin 34 of FIGS. 1 and 2. This face skin preform 34′ may be substantially the same as the face skin 34 of FIGS. 1 and 2, except without any of the face skin perforations 52 of FIGS. 1 and 2 yet formed therein. Note, the face skin perforations 52 may be machined into the preform 34′ following the bonding of the preform 34′ to the cellular core 38 as described below to form the face skin 34. It is contemplated, however, the first composite skin 82 may alternatively be the back skin 36 of FIGS. 1 and 2. Referring again to FIG. 8A, the face skin preform 34′ is disposed vertically next to and on a top of the skin support 84 such that the face skin exterior side 42 of the face skin preform 34′ is abutted against, lays on, contacts and/or otherwise engages a (e.g., top) support surface 86 of the skin support 84. The face skin preform 34′ may also be attached to the skin support 84 by a fixture and/or fasteners to temporarily fix the face skin preform 34′ to the skin support 84 for the formation method 700.

Prior to (or after) arranging the face skin preform 34′ with the skin support 84, the face skin preform 34′ may be prepared for bonding. The face skin preform 34′, for example, may be cleaned to remove any debris, fluids (e.g., oils, coatings, etc.) or the like from any mating surface or an entirety of the face skin preform 34′. The face skin exterior side 42 and the face skin interior side 44, for example, may be wiped down with isopropyl alcohol (or another solvent) and a cloth.

In step 706, a thermoplastic film 88 is arranged with the face skin preform 34′. The thermoplastic film 88 of FIG. 8A, for example, is disposed vertically adjacent and on top of the face skin preform 34′ such that a first side 90 of the thermoplastic film 88 is abutted against, contacts, lays on and/or otherwise engages the face skin interior side 44 of the face skin preform 34′.

Prior to arranging the thermoplastic film 88 with the face skin preform 34′, the thermoplastic film 88 may first be prepared for bonding. The thermoplastic film 88, for example, may be cleaned to remove any debris, fluids (e.g., oils, coatings, etc.) or the like from any mating surface or an entirety of the thermoplastic film 88. The film first side 90 and a second side 92 of the thermoplastic film 88 vertically opposite the film first side 90, for example, may be wiped down with isopropyl alcohol (or another solvent) and a cloth.

The thermoplastic film 88 is a film of the bonding material 66; e.g., a film formed from thermoplastic resin without any fiber reinforcement. However, it is contemplated the thermoplastic film 88 may alternatively include fiber reinforcement embedded within the thermoplastic resin (e.g., a matrix) in select other embodiments. This thermoplastic film 88 has a vertical thickness 94 that extends vertically between the film first side 90 and the film second side 92. This film thickness 94 may remain uniform as the thermoplastic film 88 extends laterally (e.g., axially along and/or circumferentially) along the face skin preform 34′. The film thickness 94 is sized smaller than the core thickness 68 as well as the face skin thickness 40 and the back skin thickness 54 of FIGS. 1 and 2. The film thickness 94, for example, may be sized equal to or close to a vertical thickness of a single layer (or two layers) of the face skin 34 of FIG. 3 and/or a single layer (or two layers) of the back skin 36 of FIG. 4. The present disclosure, however, is not limited to the foregoing exemplary dimensional relationships.

In step 708, referring to FIG. 8B, the thermoplastic film 88 is heated with a heating device 96. The heating device 96, for example, may be moved from a first (e.g., stowed, retracted) position of FIG. 8A to a second (e.g., deployed, heating) position of FIG. 8B. More particularly, the heating device 96 may be translated horizontally along a horizontal axis from the first position of FIG. 8A to the second position of FIG. 8B. In the second position of FIG. 8B, the heating device 96 (e.g., completely) horizontally overlaps the thermoplastic film 88. The heating device 96 is disposed vertically above and spaced vertically from the thermoplastic film 88. The heating device 96 is disposed vertically below and spaced vertically from the cellular core 38. The heating device 96 is thereby located in an air gap 98 formed by and vertically between the thermoplastic film 88 and the cellular core 38.

With the heating device 96 in the second position of FIG. 8B, the heating device 96 is energized to rapidly heat the thermoplastic film 88 through radiation. The heating device 96, for example, may be configured as or otherwise include an infrared heating device with one or more infrared heating elements 100 facing the thermoplastic film 88. When energized, the heating device 96 radiates heat energy through the air gap 98 to the thermoplastic film 88. This heat energy raises an internal temperature of and thereby heats the bonding material 66 forming the thermoplastic film 88. The heating device 96 may be operated to heat the thermoplastic film 88 and its bonding material 66 enough to melt the bonding material 66 to a softened, compliant state.

Referring to FIG. 8C, once the thermoplastic film 88 and its bonding material 66 are melted, the heating device 96 may then be moved (e.g., retracted) back to its first position and deenergized. The heating device 96, for example, may be translated horizontally along the horizontal axis from the second position of FIG. 8B to the second position of FIG. 8C. In the first position of FIG. 8C (see also FIG. 8A), the heating device 96 is (e.g., completely) horizontally offset from the thermoplastic film 88 and the cellular core 38. The heating device 96 is thereby located outside of (e.g., to a side of) the air gap 98 formed by and vertically between the thermoplastic film 88 and the cellular core 38.

In step 710, referring to FIG. 8D, the face skin preform 34′ is bonded to the cellular core 38 with the bonding material 66 of the thermoplastic film 88. The core support 76, for example, is moved vertically down from an open position of FIG. 8C (see also FIGS. 8A and 8B) towards the skin support 84 until the cellular core 38 engages the still melted thermoplastic film 88 and its melted bonding material 66. The core support 76 may then be further moved vertically down towards the skin support 84 to press the cellular core 38 against and into the melted thermoplastic film 88 and its melted bonding material 66. During this pressing, a stack of material (e.g., the members 34′, 38, 88) is biased/preloaded vertically between the core support 76 and the skin support 84.

Referring to FIG. 5, the sidewalls 72 of the cellular core 38 may press vertically into the melted thermoplastic film 88 such that the melted bonding material 66 forms one or more fillets 102 associated with each sidewall 72 as shown in FIG. 5. In FIG. 5, each fillet 102 extends vertically and laterally along the respective sidewall 72 as well as contacts the respective sidewall 72. A physical bond may thereby be provided between the bonding material 66 and the cellular core 38 and its sidewalls 72 to connect the bonding material 66 to the cellular core 38. In addition, the melted bonding material 66 may simultaneously bond with the thermoplastic matrix 48 (see FIG. 3) in the vertically adjacent face skin preform 34′ of FIG. 8D. Therefore, following cooling and solidification of the bonding material 66, the solidified bonding material 66 bonds the cellular core 38 to the face skin preform 34′ of FIG. 8D. The melted bonding material 66 may thereby provide a hot melt adhesive between the face skin preform 34′ and the cellular core 38.

While the bonding step 710 is described above with the core support 76 and its fixtured cellular core 38 moving vertically down towards the stationary skin support 84 and its fixtured face skin preform 34′, the present disclosure is not limited thereto. For example, the skin support 84 and its fixtured face skin preform 34′ may alternatively be moved vertically up towards the stationary core support 76 and its fixtured cellular core 38. In another example, both (a) the core support 76 and its fixtured cellular core 38 and (b) the skin support 84 and its fixtured face skin preform 34′ may respectively move down and up towards one another.

In step 712, a second composite skin may be bonded to the cellular core 38 using a similar methodology as outlined above for bonding the face skin preform 34′ (the first composite skin 82) to the cellular core 38. For ease of description, this second composite skin is described below as the back skin 36. It is contemplated, however, the second composite skin may alternatively be the face skin preform 34′.

In step 714, following the bonding of the back skin 36 to the cellular core 38, the face skin preform 34′ may be perforated to form the face skin 34 of FIGS. 1 and 2 and provide the acoustic panel 20.

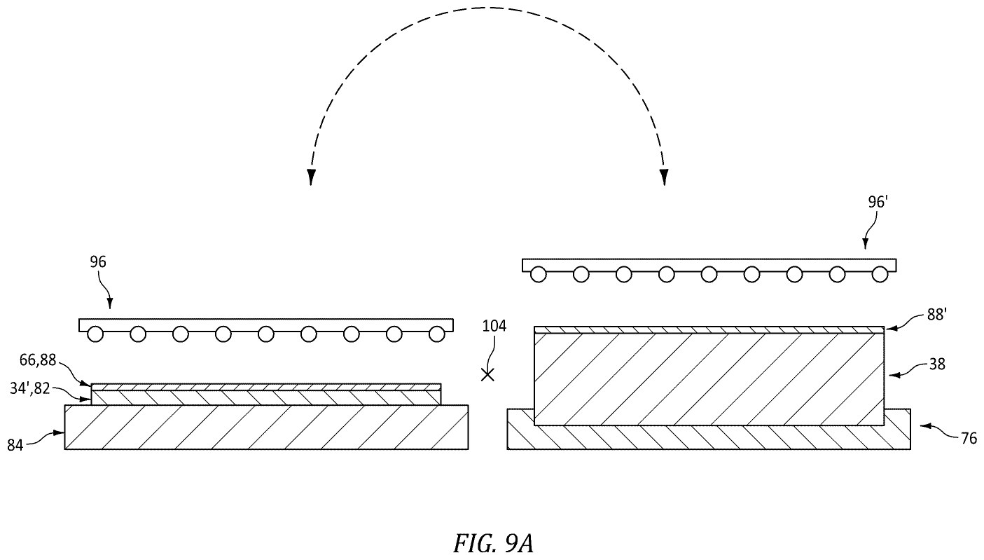

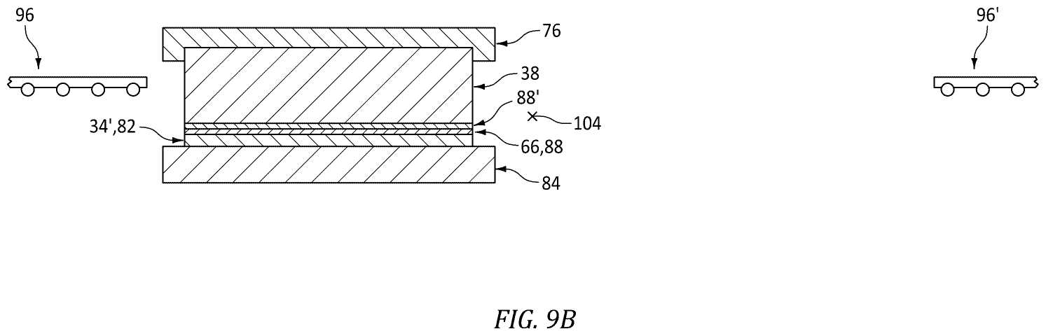

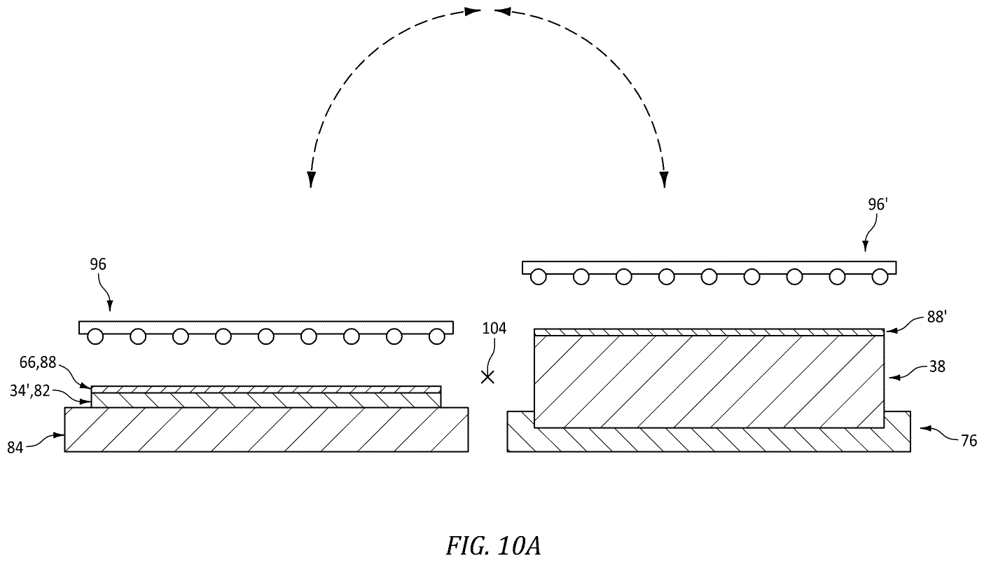

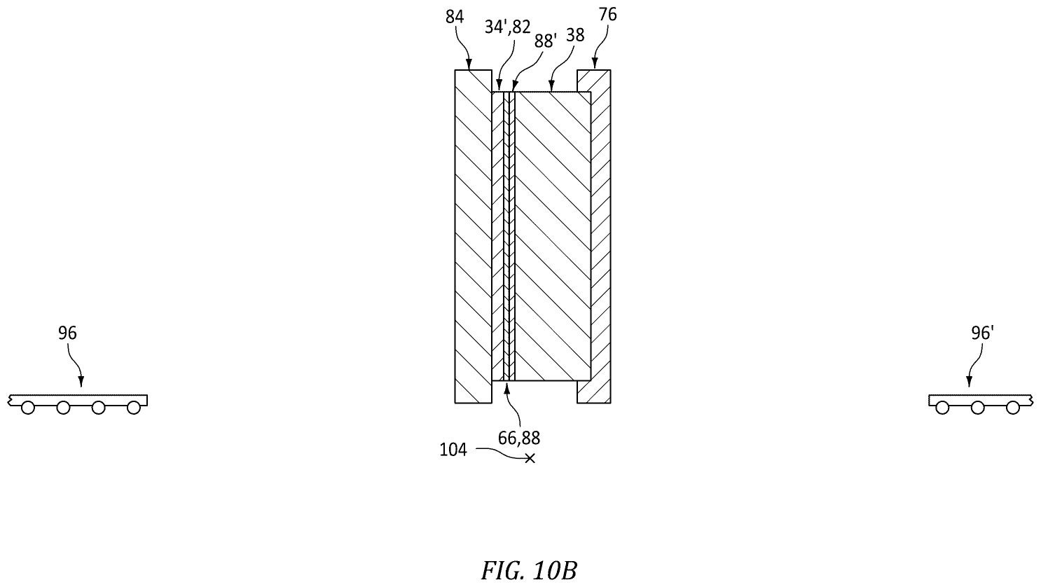

In some embodiments, referring to FIGS. 8C and 8D, the core support 76 and the fixtured cellular core 38 and/or the skin support 84 and the fixtured face skin preform 34′ (or the skin support 84 with the fixture back skin 36) may be moved (e.g., only) vertically during the formation method 700 and its bonding step. In other embodiments, referring to FIGS. 9A and 9B and FIGS. 10A and 10B, the core support 76 and the fixtured cellular core 38 may also or alternatively be rotated about an axis 104 from the open position of FIG. 9A, 10A to a pressing position of FIG. 9B, 10B. In the embodiment of FIGS. 9A and 9B, the core support 76 and the fixtured cellular core 38 are rotated about (e.g., +/−5-10°) or exactly one-hundred and eighty degrees (180°) from the open position of FIG. 9A to the pressing position of FIG. 9B. In the embodiment of FIGS. 10A and 10B, the core support 76 and the fixtured cellular core 38 are rotated about (e.g., +/−5-10°) or exactly ninety degrees (90°) from the open position of FIG. 10A to the pressing position of FIG. 10B. Here, the skin support 84 and the fixtured face skin preform 34′ are also rotated about (e.g., +/−5-10°) or exactly ninety degrees (90°) from the open position of FIG. 10A to the pressing position of FIG. 10B.

In some embodiments, referring to FIG. 8A, the cellular core 38 may be configured without its own thermoplastic film 88′. The core second side 79 of FIG. 8A, for example, is adjacent and forms the air gap 98. With this arrangement, the cellular core 38 of FIG. 8D may be pressed directly against and into the melted thermoplastic film 88 and its melted bonding material 66. In other embodiments, referring to FIGS. 9A and 10A, an additional thermoplastic film 88′ may be arranged with the cellular core 38 prior to the bonding. This additional thermoplastic film 88′ may be configured similar to or the same as the thermoplastic film 88. With such an arrangement, the thermoplastic material from both the thermoplastic film 88 and the additional thermoplastic film 88′ bond the cellular core 38 to the face skin preform 34′ (or the back skin 36). Prior to this bonding, the additional thermoplastic film 88′ and its thermoplastic material may be heated and melted in a similar fashion as the thermoplastic film 88 and its bonding material 66. An additional heating device 96′, for example, may be provided to heat and melt the additional thermoplastic film 88′ and its thermoplastic material. This additional heating device 96′ may be configured similar to or the same as the heating device 96, and may be operated similar to or the same as the heating device 96.

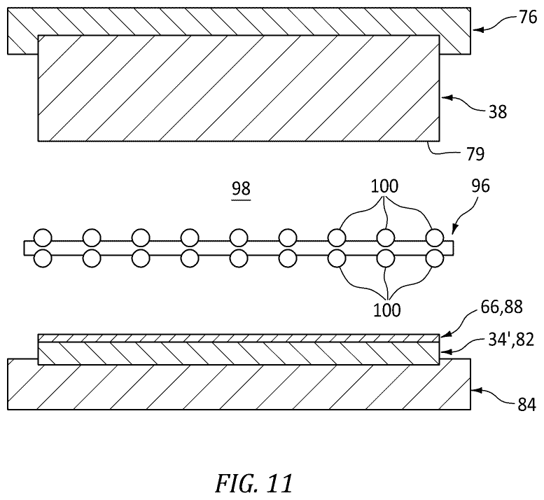

In some embodiments, referring to FIG. 8B, the heating device 96 is configured to direct the radiant heat energy (e.g., only) towards the respective thermoplastic film 88 and its bonding material 66. In other embodiments, referring to FIG. 11, the heating device 96 may also be configured to direct some of the radiant heat energy towards the cellular core 38. With such an arrangement, the cellular core 38 may also be slightly heated to further aid in the bonding of the cellular core 38 to the face skin preform 34′ (or the back skin 36). However, the cellular core 38 should not be overheated so as to compromise a structural integrity of the cellular core 38.

While various embodiments of the present invention have been disclosed, it will be apparent to those of ordinary skill in the art that many more embodiments and implementations are possible within the scope of the invention. For example, the present invention as described herein includes several aspects and embodiments that include particular features. Although these features may be described individually, it is within the scope of the present invention that some or all of these features may be combined with any one of the aspects and remain within the scope of the invention. Accordingly, the present invention is not to be restricted except in light of the attached claims and their equivalents.

What is claimed is:

1. A formation method, comprising:
arranging a thermoplastic film on a fiber-reinforced thermoplastic skin, the thermoplastic film comprising thermoplastic material;
moving a heating device to a location along the thermoplastic film, wherein the thermoplastic film is disposed between the fiber-reinforced thermoplastic skin and the heating device;
heating the thermoplastic film with the heating device to melt the thermoplastic film and provide a melted thermoplastic film;
moving the heating device away from the melted thermoplastic film; and
pressing a honeycomb core against the melted thermoplastic film to bond the honeycomb core to the fiber-reinforced thermoplastic skin with the thermoplastic material.

2. The formation method of claim 1, wherein the heating device comprises an infrared heating device.

3. The formation method of claim 1, wherein the heating device is moved by translating the heating device along an axis.

4. The formation method of claim 3, wherein the axis is parallel with the thermoplastic film.

5. The formation method of claim 1, wherein the heating device is disposed vertically between the thermoplastic film and the honeycomb core during the heating of the thermoplastic film, and the formation method further comprises moving the honeycomb core vertically towards the melted thermoplastic film after the heating device is moved away from the melted thermoplastic film.

6. The formation method of claim 5, wherein the honeycomb core is located vertically above the thermoplastic film and the heating device during the heating of the thermoplastic film.

7. The formation method of claim 1, further comprising moving the honeycomb core to a position adjacent the melted thermoplastic film prior to the pressing of the honeycomb core against the melted thermoplastic film, and the moving of the honeycomb core comprising rotating the honeycomb core about an axis.

8. The formation method of claim 7, wherein the honeycomb core is rotated ninety degrees about the axis during the moving of the honeycomb core.

9. The formation method of claim 7, wherein the honeycomb core is rotated one-hundred and eighty degrees about the axis during the moving of the honeycomb core.

10. The formation method of claim 7, further comprising rotating the fiber-reinforced thermoplastic skin with the melted thermoplastic film prior to the pressing of the honeycomb core against the melted thermoplastic film.

11. The formation method of claim 1, further comprising heating the honeycomb core with the heating device prior to the pressing of the honeycomb core against the melted thermoplastic film.

12. The formation method of claim 1, further comprising:
arranging a second thermoplastic film on the honeycomb core, the second thermoplastic film comprising second thermoplastic material;
moving a second heating device to a location along the second thermoplastic film, wherein the second thermoplastic film is disposed between the honeycomb core and the second heating device;
heating the second thermoplastic film with the second heating device to melt the second thermoplastic film and provide a melted second thermoplastic film; and
moving the second heating device away from the melted second thermoplastic film;
wherein the melted second thermoplastic film is disposed between the melted thermoplastic film and the honeycomb core as the honeycomb core is pressed against the melted thermoplastic film.

13. The formation method of claim 1, further comprising:
arranging the fiber-reinforced thermoplastic skin with a first support;
arranging the honeycomb core with a second support; and
biasing the second support towards the first support with a stack of material between the first support and the second support, the stack of material including the fiber-reinforced thermoplastic skin, the melted thermoplastic skin and the honeycomb core.

14. The formation method of claim 1, wherein the honeycomb core comprises a metal material.

15. The formation method of claim 1, wherein the honeycomb core comprises a non-metal material.

16. The formation method of claim 1, further comprising cleaning the honeycomb core prior to the pressing of the honeycomb core against the melted thermoplastic film.

17. The formation method of claim 1, further comprising cleaning the thermoplastic film prior to arranging the thermoplastic film on the fiber-reinforced thermoplastic skin.

18. The formation method of claim 1, further comprising cleaning the fiber-reinforced thermoplastic skin prior to arranging the thermoplastic film on the fiber-reinforced thermoplastic skin.

19. A formation method, comprising:
arranging a thermoplastic film on a thermoplastic skin, the thermoplastic film comprising a thermoplastic material;
moving a heating device to locate the heating device along the thermoplastic film, wherein the thermoplastic film is disposed between the thermoplastic skin and the heating device;
heating the thermoplastic film with the heating device to provide a melted thermoplastic film;
moving the heating device away from the melted thermoplastic film; and
pressing a cellular core against the melted thermoplastic film to bond a plurality of sidewalls of the cellular core to the fiber-reinforced thermoplastic skin with the thermoplastic material, the cellular core including a plurality of cavities and the plurality of sidewalls, each of the plurality of cavities extending vertically through the cellular core, and each laterally adjacent pair of the plurality of cavities separated by a respective one of the plurality of sidewalls.

20. A formation method, comprising:
arranging a cellular core on a core support, the cellular core including a plurality of cavities and a plurality of sidewalls, each of the plurality of cavities extending vertically through the cellular core, and each laterally adjacent pair of the plurality of cavities separated by a respective one of the plurality of sidewalls;
arranging a thermoplastic skin on a skin support;
arranging a thermoplastic film comprising thermoplastic material on the thermoplastic skin;
heating the thermoplastic film to provide a melted thermoplastic film; and
moving at least one of the core support or the skin support to press the cellular core against the melted thermoplastic film and to bond one or more of the plurality of sidewalls to the thermoplastic skin through the thermoplastic material, wherein the moving comprises at least one of rotating the core support or rotating the skin support.
